(19) United States
(12) Patent Application Publication
(10) Pub. No.: US 2004/0052908 A1
(43) Pub. Date: Mar. 18, 2004

(54) Tender laminated biscuits

(76) Inventors: JANET L Boyle, ST PAUL, MN (US); AMY B LARSON KOLBE, WOODBURY, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 10/246,795

(22) Filed: Sep. 18, 2002

(51) Int. Cl. A23G 3/00

(52) U.S. Cl. 426/94

(57) ABSTRACT

A laminated dough product is provided for making tender, laminated biscuits. The dough product has alternating layers of layer dough and fat layers. When the product is baked, it has a BSV of at least about 2 cc/g, and has no observable recoverable compression region in a Compression Profile Evaluation. The laminated dough product is preferably provided in frozen form, to be baked without an intermediate thawing or proofing step. Methods for preparing the unbaked tender laminated biscuits of the present invention are provided, as well as methods for preparing the final baked biscuit.

### FIELD OF THE INVENTION

The present invention relates to biscuits. More specifically, the present invention relates to laminated biscuits and methods for making same.

### BACKGROUND OF THE INVENTION

New forms of bread products are always being sought for both nutrition and for variety and interest in flavor and texture in the dining experience. Thus, bread products have grown in variety from unleavened flat breads, to leavened bread loaves, to dinner rolls, biscuits, laminated breads such as croissants, batter based products such as muffins, and so forth. New varieties of bread and bread-like products are always of interest. Convenience in preparing such products is also a highly desirable feature. The ability for a consumer to easily and quickly prepare a fresh and interesting bread product is highly valued in the marketplace.

Biscuits are traditionally a very simple bread product. In its origin as a food type, biscuits were not a very appetizing food. Named “pain bis-cuit” or “twice cooked bread,” they originally were very hard and dry, and were especially useful to the traveler and the soldier because they were very light and did not spoil. Modern biscuits are more appetizing in that they are not twice baked to such a dry state. Modern biscuits are characterized by being prepared using chemical leavener rather than yeast, and the biscuit dough is mixed only enough to incorporate all the ingredients without developing the gluten in the dough. The end product preferably has a light and moist crumb texture. The characteristic flavor of a biscuit is generally bland in nature.

Laminated bread products, such as croissants and puff pastries, are traditionally breads having distinct layers of flaky crumb and crisp crusts. The laminated dough provided a series of dough layers separated by layers of solid fat. Often these products comprise 48 to 240 layers of dough. When the laminated dough is baked, the layers remain separate and the bread puffs up to cause a large increase in volume.

Dough products that can be prepared by taking them directly from storage in the freezer and placing them in the oven for baking are particularly desirable because of the convenience to the consumer. Such dough products typically use chemical leavening systems consisting of a bicarbonate and a leavening acid to provide expansion of the product without the proofing step that is required in yeast containing products. U.S. Pat. No. 5,451,417 discloses such a product and the attempts to incorporate yeast flavor to avoid the characteristic biscuit taste and chewy sensations. See, for example, column 1, lines 62-66 and column six, lines 66-68. The product described in this patent is in the format of a baked roll.

The provision of a prebaked, chemically leavened frozen biscuit is disclosed in U.S. Pat. No. 4,746,526. This patent relates to preparation of a conventional biscuit dough to provide convenience to the consumer. The invention described therein comprises first preparing a biscuit dough, cutting this dough into biscuit preforms and baking it, followed by tempering or moisture treating the upper crust of the biscuit. The biscuit is then frozen for storage. The frozen, prebaked biscuit is reheated in the oven by the consumer. The biscuit as described therein is not a laminated biscuit, but rather it is simply a dough that has been sheeted to a thickness of about ¾ inches and cut into the desired shape and size. See column 2, lines 28-30.

### SUMMARY OF THE INVENTION

A laminated dough product is provided for making tender, laminated biscuits. The dough product has alternating layers of layer dough and fat layers. The layer dough comprises flour, a leavening agent, a fat source, and water. These ingredients are mixed in a manner to provide an underdeveloped biscuit dough. The solid fat layers alternate with the layer dough to provide a laminated product of at least about 16 dough layers. When the product is baked, it has a BSV of at least about 2 cc/g, and has no observable recoverable compression region in a Compression Profile Evaluation. The laminated dough product is preferably provided in frozen form, to be baked without an intermediate thawing or proofing step. Methods for preparing the unbaked tender laminated biscuits of the present invention are provided, as well as methods for preparing the final baked biscuit.

### BRIEF DESCRIPTION OF THE DRAWINGS

FIG. 1 is a photograph of a cross-section of a laminated biscuit of the present invention.

FIG. 2 is a photograph of a cross-section of a comparative bread product that is not a laminated biscuit of the present invention.

FIG. 3 is a photograph of a cross-section of a comparative puff pastry product that is not a laminated biscuit of the present invention.

FIG. 4 is a stress-strain graph of a comparative bread product that is not a laminated biscuit of the present invention.

FIG. 5 is a stress-strain graph of a laminated biscuit of the present invention.

### DETAILED DESCRIPTION

The present invention provides a unique bread product, which is a tender laminated biscuit. This product provides unique organoleptic properties, due to the configurational aspects of the product. Specifically, the layers of the product are tender and moist, in contrast to flaky products having the characteristic paper thin texture common in croissants and other flaky pastry type bread products. The use of fat layers to separate dough layers as used in the present invention produce large voids having a high aspect ratio. The voids sometimes span almost an entire biscuit, and are quite different from a uniformly bready product, where the voids tend to be more spherical (aspect ratio=1) and uniform in size.

Because of the unique physical characteristic of the product, the consumer may peel apart the layers for consumption. This provides a light and airy texture to the product, which is very pleasing to the consumer. The bread product is tender in consistency, so that the biscuit of the present invention has bite characteristics having a no observable recoverable compression as the consumer bites into the biscuit. Thus, there is a predictable increase in the compressive force throughout the bite.

In one aspect of the present invention, the tender laminated biscuit of the present invention is provided as a frozen product suitable for freezer-to-oven (FTO) preparation. In other words, the product may be taken as is in the unproofed frozen state, and placed directly into the oven for baking without an intermediate thawing or proofing step. This embodiment provides exceptional convenience to the consumer, with a highly pleasing final baked product. Because of the design of the dough product as a leavened laminated product, the baked product experiences a tremendous increase in volume as compared to the product in the prebaked, frozen state. The present invention provides a product that may experience a volume increase of greater than 200%, and preferably greater than 250%, after being baked.

A laminated dough product of the invention includes a layer dough alternating with solid fat layers. The layer dough of the invention includes flour, water, a leavening agent, and a fat source. These ingredients, and additional ingredients that may optionally be added to provide desired textural or flavor properties as discussed below, are mixed in a manner to provide an underdeveloped dough. The layer dough is then sheeted, and the solid fat is laminated with the sheeted dough. The layer dough and solid fat layer are then subjected to repeated lapping and sheeting to form a laminated dough product.

After baking, the final product exhibits configurational characteristics that are unique. These characteristics may be observed by reference to the Drawings.

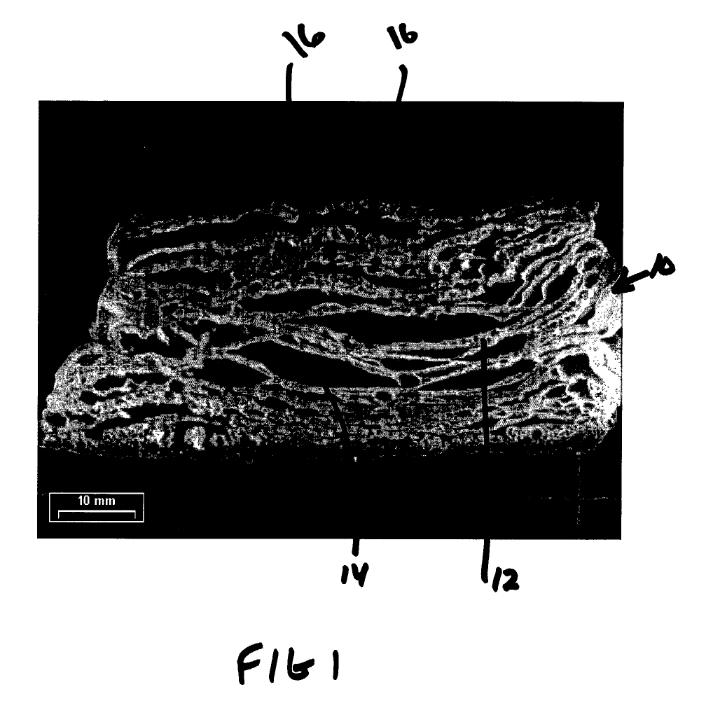

Turning to the Drawings, FIG. 1 is a photograph of a cross-section of a laminated biscuit 10 of the present invention having distinctly identifiable dough layers 12 that may be readily observed by inspection of photographs of this magnification. Typically, dough layers 12 are of a thickness of from about 150 to about 500 microns prior to being baked, and result in a plurality of baked layers having a thickness of about 0.2 to about 8 mm, and more preferably from about 0.5 to about 6 mm. Large spaces 14 between dough layers 12 are characteristically present in laminated biscuit 10, which are elongated in shape and which provide both high loft and the unique texture as the consumer bites into the product. Large spaces 14 further optionally facilitate separate of dough layers 12 from each other. Dough layers 12 additionally contain small bubbles 16 within the layer, providing the unique tender characteristic that is distinct from typical croissants or flaky pastries. Small bubbles 16 typically are of a size of about 0.25 to about 1.25 mm in diameter, and are present in substantially the same bubble density as a like leavened biscuit of the same dough recipe that is not laminated.

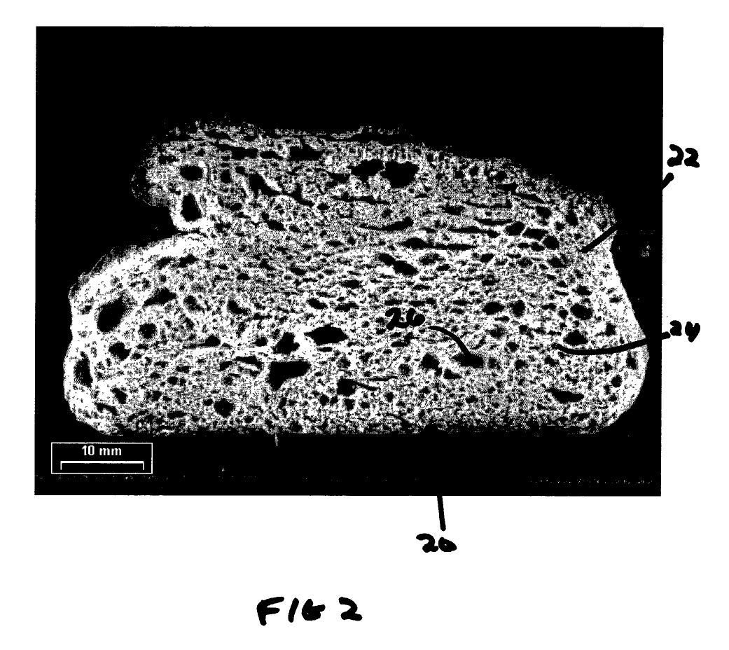

FIG. 2 is a photograph of a cross-section of a bread product 20 that is not a laminated biscuit of the present invention. Bread product 20 has a crumb 22 containing small air bubbles 24. Large air bubbles 26 are additionally present in the bread product 20, but are more nearly round in character and are not elongated. The overall appearance of the cross section of bread product 20 is as a uniform sponge, rather than a laminated dough product.

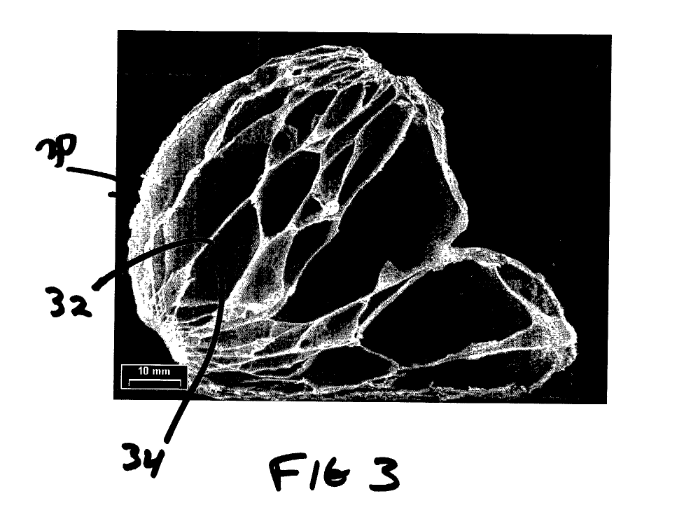

FIG. 3 is a photograph of a cross-section of a puff pastry product 30 that is also not a laminated biscuit of the present invention. Puff pastry 30 comprises dough layer 32 separated by large spaces 34, resulting from expansion and separation at fat layers located between the dough layers prior to baking. Dough layers 32 are paper-thin in character, and do not contain visible air bubbles within the layer.

Laminated biscuits of the present invention have a BSV of at least about 2 cc/g, preferably about 2.5 cc/g to about 4.5 cc/g, and more preferably about 3 cc/g.

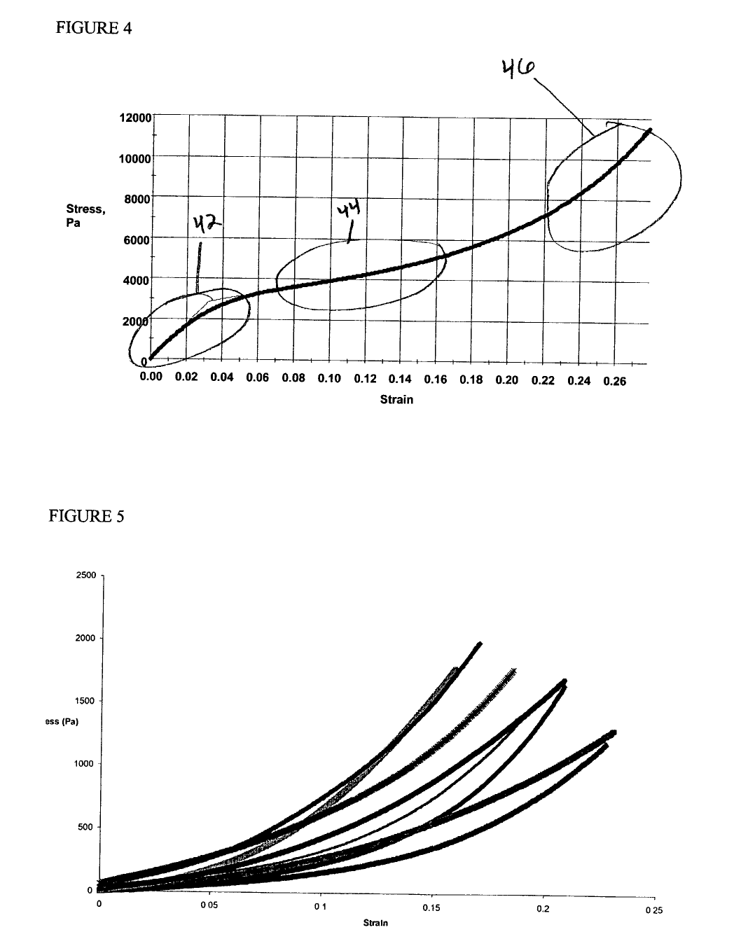

Laminated biscuits of the present invention exhibit unique textural properties due to the configuration of layers as described above. Specifically, the biscuits of the present invention preferably exhibit a unique compression profile for a laminated bread product as evaluated using a Compression Profile Evaluation protocol as discussed in more detail below. Traditional laminated products, such as flaky pastries, compress in a manner similar to a sponge. Thus, the stress-strain curve of a flaky pastry as shown in FIG. 4 exhibits a first region 42 corresponding to recoverable compression, a second region 44 corresponding to foam collapse, and a third region 46 corresponding to densification of the bread product. In contrast, the tender biscuit product of the present invention compresses more like a stack of sheets of paper. Thus, the stress-strain curves of a number of samples of tender biscuit products of the present invention as shown in FIG. 5 exhibit little initial resistance to initial compression, with no observable recoverable compression and only foam collapse and densification being observed.

In a particularly preferred embodiment of the present invention, the biscuit product is provided in an unbaked and unproofed form in the frozen state. This product may be baked directly in the frozen state without being thawed out or proofed. This embodiment of the present invention provides substantial benefit both in the ultimate organoleptic properties of the product, and also in convenience in preparing the product for consumption. For purposes of the present invention, the term “unproofed” means that the dough is provided in a state wherein it contains sufficient unactivated leavening agent that the dough product will at least double in volume when baked from the frozen state. Thus, while some chemical leavening agent may have interacted with ingredients in the dough process during mixing to generate some gases, a sufficient amount of the leavening agent is still available to be utilized to proof the dough during baking. For purposes of the present invention, the term “frozen” describes dough products that are maintained at a temperature below the freezing point of water, regardless of whether all ingredients in the dough product are actually in the frozen state.

One advantage of a laminated dough product of the invention is that it does not need to be proofed before freezing or before baking and does not need to be thawed before baking, which is useful for saving preparation time and storage space. That is, a laminated dough product of the invention does not need to be preproofed, but it can still provide a desirable baked product.

Typically, a layer dough of the invention includes flour, water, a leavening agent, and a fat source. The layer dough can also contain one or more of several additional ingredients, such as dough stabilizing agents. The laminated dough product of the invention also includes at least about 16 layers, preferably about 20 to about 48 layers of solid fat, and more preferably about 25 to about 36 layers of solid fat. A solid fat layer includes shortening as described below.

The layer dough of the invention includes flour as a grain constituent that contributes to the structure of the dough, and also contributes to tenderness. Wheat flour is a grain constituent that is frequently used in baked goods. Preferably, the flour used in the dough of the present invention is a blend of hard wheat winter and spring flours to provide superior properties of structure and tenderness. Most preferably, the flour is a blend of about 70-90% of hard winter flour (preferably having a protein content of about 10-13%) and about 10-30% of a soft red winter wheat flour (preferably having a protein content of about 7-9%). Optionally, flours can be supplemented with a protein supplement such as gluten, for example, when the protein content of the flour is lower than desired.

A layer dough of the invention typically includes an amount of flour effective to provide structure to the layer dough. That is, a layer dough of the invention includes flour in an amount effective to provide desirable layer dough consistency. The amount of flour should not be so high that the layer dough is dry and loses its ability to expand. However, the amount of flour should not be so low that the layer dough is so soft that it merges with the solid fat layers when formulated into a laminated dough product of the invention. A layer dough of the invention can include flour in an amount of about 30 weight percent to about 50 weight percent, preferably about 35 weight percent to about 45 weight percent, and more preferably about 35 weight percent to about 40 weight percent, as calculated based upon the total weight of the layer dough.

As described herein, the flour includes moisture and protein. Thus, the flour contributes to the moisture content of the layer dough, as well as the total protein content of the layer dough. The flour amounts described above are based on flour having about 12 weight-percent to about 14 weight-percent moisture, about 12 weight-percent to about 14 weight-percent wheat protein, and about 0.4 weight-percent to about 0.6 weight-percent ash based on the amount of flour. One skilled in the art having read the present specification would understand that flour amounts suitable for use with a layer dough of the invention can vary depending upon the characteristics of flour used. For example, when a flour with a lower moisture and/or protein content is used, the percentages given above will vary.

The term “weight percent” as used herein is based on the total weight of the laminated dough product including the flour-water layers and the solid fat layers, unless specifically indicated to the contrary.

A layer dough of the invention also includes water. Water can act as a plasticizer, a leavening agent, or both. The total amount of plasticizers (e.g., the amount of water from all sources) should be effective to provide a desirable layer dough consistency suitable for a layer dough of the invention. When water acts as a plasticizer, water gives extensibility to the layer dough, which facilitates the molecules moving and stretching. Desirable extensibility facilitates the laminated dough product of the invention baking into a product having a desirable specific volume. Moreover, water can facilitate the leavening of a laminated dough product of the invention by forming steam, which acts as a leavening agent.

The amount of water in the layer dough will vary depending upon such factors as the amount of plasticizers (i.e., the amount of moisture provided by other sources than the water in the layer dough) and dry ingredients used in the formulation, the humidity of the processing conditions, the length of processing time, and the like. The total amount of plasticizers in the layer dough should not be so high that the layer dough is so soft that it loses its layers as a result of merging of the layer dough with the solid fat layers. However, the total amount of plasticizers should not be so low that the layer dough is so dry that it loses its ability to expand. Typically a dough of the invention includes flour and water in a flour-to-water ratio in a range of about 1.5:1 to about 2.5:1, preferably about 1.6:1 to about 2.1:1, and more preferably about 1.7:1 to about 2:1.

A layer dough of the invention also includes a leavening agent to increase the volume and alter the texture of a baked product prepared by a laminated dough product of the invention. Typically, the leavening agent saturates the dough with carbon dioxide, providing voids in the dough matrix and enhancing the volume of the dough. Leavening agents suitable for use in a laminated dough product of the invention include air, steam, yeast, chemical leaveners, and the like. The amount of leavening agent is effective to leaven a baked product prepared from a laminated dough product of the invention.

A preferred leavening agent comprises a chemical leavening agent. Chemical leavening typically involves the interaction of a leavening acid and a leavening base, such as sodium bicarbonate. The leavening acid triggers the release of carbon dioxide from bicarbonate upon contact with moisture.

The evolution of carbon dioxide essentially follows the stoichiometry of typical acid-base reaction. The amount of leavening base present determines the amount of carbon dioxide evolved, whereas the type of leavening acid affects the speed at which the carbon dioxide is liberated. The amount of leavening base used in combination with the leavening acid should be balanced such that a minimum of unchanged reactants remain in the finished product. An excess amount of leavening base can impart a bitter flavor to the final product while excess leavening acid can make the baked product tart.

Sodium bicarbonate, or baking soda, is a leavening base that is the primary source of carbon dioxide gas in many chemical leavening systems. This compound is stable and relatively inexpensive to produce. Other leavening bases include potassium bicarbonate, ammonium carbonate, and ammonium bicarbonate.

Examples of suitable leavening acids include sodium or calcium salts of ortho, pyro, and complex phosphoric acids in which at least two active hydrogen ions are attached to the molecule. Baking acids include monocalcium phosphate monohydrate (MCP), monocalcium phosphate anhydrous (AMCP), sodium acid pyrophosphate (SAPP), sodium aluminum phosphate (SALP), dicalcium phosphate dihydrate (DPD), dicalcium phosphate (DCP), sodium aluminum sulfate (SAS), glucono-delta-lactone (GDL), potassium hydrogen tartrate (cream of tartar), and the like. Particularly preferred leavening agents comprise a mixture of SAPP and SALP, used in combination with bicarbonate, in Freezer-to-Oven products.

Optionally, the chemical leavening agents are encapsulated. Suitable materials that can be used to encapsulate the leavening agent include fats, maltodextrin, and proteinaceous materials. Encapsulation materials and processes are known, and are described, for example, in U.S. Pat. No. 5,855,945 (Laughlin et al., commonly owned by the assignee of the present application, and incorporated herein by reference).

An alternative leavening agent is yeast. Yeast as leavening agent provides such desirable qualities as specific volume, flavor, and texture. Compressed yeast may optionally be present in an amount of about 0.5 weight percent to about 6 weight percent, preferably about 0.75 weight percent to about 5 weight percent, and more preferably about 3 weight percent to about 4 weight percent based on the total weight of the layer dough. The amount of yeast used according to the invention is sufficient to provide desirable flavor, oxidation, and texture in the baked product.

A layer dough of the invention also includes a fat source. The amount and type of fat may be carefully selected to avoid oil-out and gumminess of layers in the baked product. As described herein, the fat source can comprise components that act as lubricants in the layer dough. According to the invention, a fat source contributes to a baked product having desirable palatability, physical texture, physical form, and overall aesthetic appeal. The fat source generally provides a baked product with a tender, soft, fluffy mouth feel; and a crisp outer crust with a glossy appearance. The fat source can also contribute to the volume and grain of a baked product.

Suitable fat sources include shortening and oils. In one embodiment, the fat source comprises a shortening. Shortening in the layer dough can be either from an animal or vegetable source. Shortening in the layer dough generally includes fats and fatty oils, which are made of predominantly triesters of glycerol with fatty acids, commonly called triglycerides. The number of triglycerides in a given natural fat is a function of the number of fatty acids present and specificity of the enzyme systems involved in that particular fat-synthesis reaction.

Fats and fatty oils useful in producing shortening consistent with the invention include cottonseed oil, ground nut oil, soybean oil, sunflower oil, rape seed oil, sesame oil, olive oil, corn oil, safflower oil, palm oil, palm kernel oil, coconut oil, and combinations thereof. In addition to being useful in producing shortening, these and other similar oils can be used as the fat source. Another example of a suitable fat source in the layer dough is butter.

The layer dough in the laminated dough product of the invention can include any number of compositions that include fat and have a variety of physical states and/or physical forms. Suitable physical states of the fat source include liquid, semisolid, and solid. Suitable physical forms of shortening include plasticized shortening, chip shortening, and extruded shortening. Preferably, the fat in the layer dough includes butter, hydrogenated vegetable oil, or a combination thereof.

The amount of fat source in the layer dough of the invention is effective to provide a baked product having a tender, soft, fluffy mouth feel and a crisp outer crust. The fat source in the layer dough is also provided in an amount effective to increase the expansion of the dough during baking. The amount of fat source should not be so high as to provide the baked product of the present invention with a gummy texture. However, the amount of the fat source included in the composition should not be so low that a laminated dough product of the invention provides a baked product having a tough, dry, crumbly texture and a less than desirable specific volume.

The amount of fat source (e.g., shortening) present in the layer dough is preferably in a range of about 1 weight percent to about 3 weight percent, and more preferably about 2 weight percent to about 2.5 weight percent based on the total weight of the laminated dough product.

The layer dough of the invention also typically includes sugar and salt. Salt can enhance the flavor of a baked product prepared from a laminated dough product of the invention, impart toughness to the gluten, and provide strength to the crumb. Salt can be present in an amount effective to provide a desirable flavor. Salt is typically present in a range of about 0.3 weight percent to about 1 weight percent.

Sugar can also enhance the flavor of a baked product prepared from a laminated dough product of the invention. Sugar acts as a substrate for yeast and as a starting material for the Maillard reaction, which facilitates color formation of the crust. Sugar is typically present in a range of about 1 weight percent to about 8 weight percent. The amount of sugar used in the product will vary depending upon such factors as the overall sweetness of the product to be formed by the laminated dough product. For example, sweet products typically include a higher amount of sugar than other products that are not formulated to be as sweet. It has been found that a sugar concentration of greater than about 4 weight percent can, in some embodiments, have an adverse effect (or a “deadening effect”) on the specific volume of the final baked product. Suitable sugar includes granulated sugar, honey, high fructose corn syrup, and the like.

The dough of the invention can also include additives, for example, emulsifiers, dough-developing agents, nutritional supplements, flavorings, shelf-life stabilizers, organic acids, dough stabilizing agents (e.g., oxidizers), and the like. Additives can modify texture or any number of characteristics of a laminated dough product of the invention or a baked product resulting therefrom.

An emulsifier can influence the texture and homogeneity of the dough mixture, increase dough stability, and improve the eating quality of a baked product. An emulsifier includes nonionic surfactants, anionic surfactants, and cationic surfactants. Suitable emulsifiers include, for example, lecithin, mono- and diglycerides of fatty acids, propylene glycol monoesters and diesters of fatty acids, glyceryl-lacto esters of fatty acids, ethoxylated monoglycerides and diglycerides, sodium stearoyl lactylate, diacetyl tartaric acid esters of monoglycerides, and the like.

In one embodiment, a layer dough of the invention includes an emulsifier including sodium stearoyl lactylate, diacetyl tartaric acid ester of monoglycerides and diglycerides (DATEM), or a combination thereof.

A dough-developing agent can enhance the elasticity or extensibility of a dough, and more preferably may be incorporated for reducing the overall mix time required in preparing the dough. Any number of dough-developing agents can be used including, for example, azodicarbonamide, ascorbic acid, sodium bisulfite, potassium bromate, benzoyl peroxide, and organic acids such as potassium sorbate or salts of organic acids. In addition, enzymes such as transglutaminase or lipoxygenase can be used. One example of such an enzyme is a transglutaminase, amylase and hemicellulase enzyme product available from Rohm Enzyme grnbh, under product name “Veron CLX.” In one embodiment, a layer dough of the invention includes a dough-developing agent including azodicarbonamide, ascorbic acid, or a combination thereof.

A nutritional supplement can be added to a layer dough of the invention. Examples of suitable nutritional supplements include vitamins, minerals, proteins, and the like can be added to a layer dough of the invention. Examples of nutritional supplements include thiamin, riboflavin, niacin, iron, calcium, and the like.

Flavorings such as, for example, sweeteners, spices, and specific flavorings can be added to a laminated dough product of the invention. Sweeteners include, for example, honey, regular and high fructose corn syrup, sucrose (cane or beet sugar), dextrose, and the like.

Shelf-life stabilizers such as, for example, preservatives and mold inhibitors can be added to a laminated dough product of the invention. Suitable shelf-life stabilizers include, for example, sodium salts of propionic or sorbic acids, as well as emulsifiers such as sodium stearoyl lactylate, and the like.

Dough stabilizing agents such as oxidizers can be added to the layer dough of the invention to provide shelf life stability. Examples of suitable oxidizers include ascorbic acid, azodicarbonamide, bromate, and the like.

A layer dough suitable for providing the flour-water layers in a laminated dough product of the invention can be prepared according to methods known in the art for preparing underdeveloped dough. Thus, the biscuit dough is prepared by mixing the dough composition only enough to incorporate all the ingredients without fully developing the gluten in the dough. As is appreciated by those of skill in the baking art, a biscuit dough is distinct from bread-like doughs due to the degree of development of the dough. A tool to quantify the nature of the extent of development of the dough is a farinograph, which is a common flour and dough quality measuring device which measure the resistance of the dough to mixing (reported in Brabender units (B.U.)). As dough is mixed, the resistance to mixing increases until a peak is reached, after which the resistance to mixing decreases. Typical bread doughs tend to peak within about 3 minutes, indicating that the dough is fully developed. A biscuit dough, in contrast, will take longer to reach a peak resistance, indicating that the dough is underdeveloped. Biscuit doughs typically reach a peak of resistance in a time period greater than about 7 minutes, and preferably greater than about 10 minutes.

In one embodiment, a layer dough can be prepared by combining all ingredients and mixing until the layer dough is developed to the desired degree.

A layer dough can be mixed in any mixer suitable for combining the ingredients and mixing until the layer dough is developed to the desired degree. An example of a suitable mixer includes a vertical mixer (Hobart, Troy, Ohio). During mixing, the layer dough of the invention is desirably maintained at a temperature that maintains the structure of the layer dough to facilitate handling of the layer dough. Typically the temperature should be in a range of about 50° F. to about 70° F.

Preferably the mixer is equipped with a refrigeration system such as, for example, a jacketed glycol coolant to maintain the layer dough of the invention within the desirable temperature range.

To maintain the desirable temperature, the water added should be at a temperature suitable for maintaining the dough at the desirable temperature. Preferably the water is chilled to a temperature of about 45° F. to about 60° F. To further control the temperature, a portion of the water can be replaced by shaved or crushed ice. The amount and size of the shaved or crushed ice can be determined so that the ice can melt in the water, the dough, or both during mixing without leaving ice in the mixed dough. The size of the shaved or crushed ice can typically be up to about 1 cm. The portion of water that is replaced by shaved ice can be up to about 70 weight percent of total water.

The layer dough is mixed at a speed and time that are suitable for developing the layer dough to the desired degree. For example, the ingredients can initially be mixed on low speed for about 30 seconds and then mixed on medium speed for about 2 minutes to about 5 minutes. These times and speeds are merely illustrative and can vary depending on the amount of layer dough being mixed and on the type of mixer.

After mixing, a layer dough desirably has a temperature of about 50° F. to about 70° F., preferably about 55° F. to about 65° F.

A layer dough to be used in the present invention desirably has a maximum resistance of 650 to 1000 Brabender units (B.U.), and more preferably about 700 B.U. to about 900 B.U. Additionally, the dough has an extensibility of about 30 to about 175 mm, and more preferably from about 70 to about 100 mm, and a resistance at 30 mm extension of about 410-550 BU (as determined by Extensograph® measurement device, available from Brabender® OHG, Dulsberg, Germany).

The laminated dough product of the invention comprises layer dough alternating with solid fat layers. The fat in the solid fat layers of a laminated dough product of the invention includes any appropriate fat, such as hydrogenated vegetable oil, a solid fat combined with water (e.g., margarine), butter, animal fat (e.g., beef tallow or lard), or combinations thereof. Preferably the solid fat comprises butter.

The fat in the solid fat layers typically is in a range of about 8 to about 22 weight percent, and more preferably from about 12 to about 17 weight percent, of the total laminated biscuit product prior to baking. These amounts do not include the amount of fat, if present, in the layer dough.

To prepare the solid fat to be rolled into the layer dough, the solid fat may optionally be conditioned in any appropriate manner to facilitate lamination with the layer dough. For example, the solid fat may optionally be creamed. Creaming solid fat includes mixing solid fat in a manner effective to soften the solid fat. Preferably the solid fat is softened to an extent that it simulates extruded solid fat in a continuous application, as known in the art. The creaming process can be performed in a mixer.

If the solid fat is undermixed, then undesirable lumps of solid fat can remain in the creamed solid fat. But if the solid fat is overmixed, then the solid fat can break down, resulting in free water. As an example, the solid fat can be creamed by mixing the solid fat at low speed of a mixer for about 1 minute to about 2 minutes and then mixing the solid fat at medium speed of a mixer for about 3 minutes to about 4 minutes or more.

A laminated dough product of the invention can generally be prepared by mixing the above-described ingredients to form a layer dough to provide the layer dough, rolling in the solid fat layers, shaping the laminated dough product, and optionally freezing the laminated dough product. One skilled in the art having read the specification would understand that the mixing and rolling steps are generally performed using accepted techniques for the product to be made.

After mixing, the dough is sheeted or extruded to prepare the dough for the addition of laminating solid fat. Dough can be handled in individual pieces for example, or as a continuous sheet. A dough can be sheeted on a continuous or reversible sheeter.

According to the invention, roll in solid fat is applied onto the surface of the layer dough to prepare a sheet dough. Preferably, the solid fat is applied after creaming as either a premeasured proportion (in the amounts as discussed above) of each dough piece or extruded onto a continuous flow of sheeted dough.

After application of the solid fat to the layer dough, the combination so prepared is folded, thereby completely enveloping the fat within the dough while attempting to maintain both the layer dough and roll-in solid fat as distinct layers. The sheet dough can be repeatedly folded and sheeted, using techniques known in the art, to provide a desired number of solid fat layers in the laminated product. The term “folding” as used in the context of this invention includes the incorporation and maintenance of layers of solid fat between adjacent layers of dough. Solid fat can be rolled into the dough to provide a laminated dough product of the invention having at least about 16 fat layers, preferably about 20 to about 48 layers, and more preferably about 32 to about 38 layers. Preferably, the solid fat layer is applied and maintained at a sufficiently low temperature to avoid having the solid fat melt into the layer dough and also to maintain the integrity of the layer dough.

Between sheeting steps, the dough can optionally be refrigerated to avoid having the solid fat melt into the layer. The thus formed product prior to baking preferably has at least 16 fat layers, each fat layer preferably having a thickness of about 20-350 microns, and more preferably from about 50-200 microns. The formed product prior to baking additionally has at least about 16 dough layers, each dough layer preferably having a thickness of about 100-1000 microns, and more preferably from about 150-500 microns.

After sheeting, the laminated dough is optionally cooled, and is shaped and/or cut into the desired pre-baked product shape. In one embodiment, the solid fat that is creamed and sheeted includes butter. When butter is rolled into a dough to prepare a laminated dough product of the invention, the butter can be at a temperature of about 48° F. to about 68° F., preferably about 50° F. to about 65° F., and more preferably about 50 F. to about 55° F.

After completion of the folding and sheeting sequence, the laminated dough can be rolled and shaped.

In one embodiment, a laminated dough product having 36 solid fat layers can be prepared. To prepare a laminated dough product having 36 solid fat layers, the following procedure can be used. First, the layer dough is prepared and sheeted to a thickness of about 10-12 mm. Solid fat is then applied to the layer dough in a roller process, and the combination laminate of layer dough and fat layer is sheeted to a thickness of about 10-12 mm. This laminate is four folded, and resulting laminate comprising four fat layers is sheeted to a thickness of about 12-15 mm. This laminate is three folded, and the resulting 12 fat layer laminate is sheeted to thickness of about 12-15 mm. This laminate in turn is three folded, and the resulting 36 fat layer laminate is sheeted to thickness of about thickness of about 5 mm to about 20 mm, and more preferably about 7 mm to about 12 mm. The 36 fat layer laminate is cut into biscuit shapes. During this folding process, the folded laminate can be placed in a cooler to rest for an amount of time effective to avoid tearing and disruption of the layers through subsequence sheeting. In some instances, the amount of time can be about 30 minutes to about 60 minutes and preferably about 30 minutes to about 40 minutes. The dough can be rested in this manner between each folding stage.

The laminated dough can then be rolled and formed into desirable shapes such as the shapes typically used for biscuits. Preferred shapes include hexagonal or round shaped biscuits. When making large quantities of biscuits, as in a mass production facility, the hexagonal shape is particularly. The rolled and shaped laminated dough does not need to be flattened by, for example, passing between rollers to prepare a desirable baked product.

Optionally, the tender laminated biscuits of the present invention may additionally be provided with fillings or flavorants. The filling or flavorant may be sweet or savory, depending on the desired flavor sensation for the ultimate product. When the filling or flavorant is sweet, it preferably has an additional flavor imparted thereto, such as cinnamon, maple syrup, or fruit such as orange, blueberry, or any other desired flavor. Alternatively, the filling or flavorant may be savory in flavor, such as cheese flavored, beef, chicken and the like.

Preferably, the filling or flavorant has a water activity that is compatible with the biscuit dough. By this is meant that the water activities of the biscuit dough and the filling or flavorant are selected such that water transfer from one material to another during storage has minimal deleterious effects to either the filling or flavorant or the dough of the biscuit product. Preferably, the water activity of the filling or flavorant and the dough composition is selected such that there is no deleterious visual effect to either component over the expected storage time of the product. Additionally, the water activity of the filling or flavorant and the dough composition is preferably selected such that there is no deleterious organoleptic effect to either component over the expected storage time of the product.

In one embodiment of the present invention, the laminated biscuit prepared as described above may be baked immediately after preparation for either immediate consumption or packaging in the baked state either as a refrigerated product or as a frozen product. Alternatively, the unbaked laminated biscuit may be packaged for storage in an appropriate manner, particularly for refrigerated storage or frozen storage.

When the unbaked laminated biscuit of the present invention is packaged for refrigerated storage, the product may optionally be proofed prior to packaging, proofed while in the package prior to delivery to the consumer, or alternatively packaged in a manner such that proofing does not take place until desired by the consumer. As an example of delayed proofing, the leavening agent may be selected such that it is not activated until the product reaches a temperature above the refrigerated storage temperature.

As noted above, a particularly preferred embodiment of the present invention provides the biscuit product in the form of a frozen unproofed product suitable for freezer to oven preparation. In this embodiment, after the laminated dough is formed into a desirable shape and deposited into a container, the laminated dough product of the invention is frozen to a temperature suitable for shipping the product. The product is preferably frozen as quickly and completely as possible. The product is preferably frozen at a temperature of about −10° F. to about −35° F. Generally this freezing process reduces the temperature of the product to at least 5° F.

In any of the above embodiments, the product may optionally be stored under controlled atmosphere conditions, such as being encased within a container that is flooded with carbon dioxide or nitrogen gas. Storage in a controlled atmosphere may provide enhanced stability with respect to the baked specific volume of the product.

The laminated dough product of the invention can be removed from the freezer and placed directly in an oven without thawing, with the result that the dough proofs in the oven during baking. This embodiment of the present invention thus eliminates a separate proofing step. The oven can be cold or preheated. The baking temperature and time can depend on, for example, the size and shape of the laminated dough product, as well as whether the oven is cold or preheated. The temperature of the oven can be in a range of, for example, about 350° F. to about 400° F., preferably about 370° F. to about 385° F. The dough can be baked at this temperature until the product achieves the desired color and degree of doneness, for example about 8 minutes to about 32 minutes, and more preferably about 10 minutes to about 20 minutes.

The laminated dough product of the invention can also be prepared by thawing from the frozen state, for example by holding the product at a temperature of about 40° F. overnight, followed by baking the product. One skilled in the art would understand that the baking time and temperature can vary depending upon, for example, the temperature of the dough when it is placed in the oven.

Compression Profile Evaluation

The compression characteristics of fresh, cool, baked products are evaluated by measurement of the compression of a sample in an Instron model 1011 with a 5 kg load cell or other compressive testing device. Samples could also be evaluated using AACC (American Association of Cereal Chemists) approved method 74-09. To evaluate the sample, the crust of the baked product is removed in order to evaluate the crumb. A cylindrical plug, with the same diameter of the compression plate (53.3 mm), is then cut from the sample. The sample is loaded for testing with the compression plane parallel to lamination layers, if present, at a crosshead speed of 5 mm/min, compressing approximately 80% of the material. A plot of strain vs. stress is generated and evaluated to determine whether a recoverable compression region (initial modulus) in the plot may be observed, as is evidenced by the first slope of the stress-strain curve.

Method for Determining the Number of Shortening Layers And the Shortening Layer and Dough Layer Thickness in Laminated Dough

1. A 15 mm strip is cut from the center of the frozen biscuit and cut into 20 micron sections with a cryostatic microtome.

2. Sections are stained with iodine vapors until the starch is dark blue-black.

3. Sections are imaged with a polarizing light microscope using crossed polars at a magnification of 24×.

4. The shortening appears birefringent or bright in polarized light. Layers are visually counted from the image.

5. Distributions of the shortening layer thickness and dough layer thickness are determined using a Qwin 570 image analyzer.

Bubble Analysis

A section is cut from the center of the baked biscuit, and imaged in an environmental scanning electron microscope. The estimated bubble distribution was determined by image analysis of smaller bubbles having a more spherical appearance, i.e. the aspect ratio (length/width) is about 1.

The following examples are offered to further illustrate the various specific and preferred embodiments and techniques. It should be understood, however, that many variations and modifications may be made while remaining within the scope of the present invention. For example, the particular materials and amounts thereof recited in these examples, as well as other conditions and details, are to be interpreted to apply broadly in the art and should not be construed to unduly limit the invention.

### EXAMPLES

### Example 1

A dough was prepared by mixing ingredients in a two-stage process. In the first stage, ingredients as listed in Table 1 below were added to a mixing vessel and mixed at a speed of about 32 rpm for about 30 seconds to blend the ingredients, and then mixed at a speed of about 80 rpm for about 3 to 4 minutes. The second stage ingredients were then added as in amounts indicated as listed in Table 1 below were added to the mixing vessel, mixed at a speed of about 32 rpm for about 30 seconds to blend the ingredients, and then mixed at a speed of about 80 rpm for about 3 minutes.

The thus prepared dough was sheeted, and roll in solid fat was applied in the amount indicated in Table 1 below. The resulting layer dough/solid fat laminate was lapped to an construction having 36 layers, and hexagonal biscuit shapes were cut therefrom. The biscuits were 10 mm thick, with a widest diameter of about 8.3 cm. The thus formed biscuits were frozen to a temperature of less than 5° F.

After one day, the frozen biscuits were placed in an oven that had been preheated to a temperature of about 375° F., and baked for about 18-22 minutes. The resulting biscuits had a BSV of about 3.0 cc/g, and exhibited an expansion of about 200%.

TABLE 1

| Ingredient | Dough % | Biscuit with rollin % |
|---|---|---|
| Flour, hard | 38.52 | 33.51 |
| Flour, soft | 9.66 | 8.06 |
| Water | 33.48 | 27.92 |
| Dairy Solids | 4.33 | 3.61 |
| Emulsifier | 0.92 | 0.77 |
| Egg Protein | 0.46 | 0.38 |
| Flavor | 0.28 | 0.23 |
| Dough Shortening/Oil | 2.57 | 2.15 |
| Leaveners | 3.06 | 2.73 |
| Salt | 1.19 | 1.00 |
| Sugars | 5.33 | 4.64 |
| Roll in shortening | | 15 |

All patents, patent documents, and publications cited herein are incorporated by reference as if individually incorporated. Unless otherwise indicated, all parts and percentages are by weight. The foregoing detailed description has been given for clarity of understanding only. No unnecessary limitations are to be understood therefrom. The invention is not limited to the exact details shown and described, for variations obvious to one skilled in the art will be included within the invention defined by the claims.

We claim:

1. A laminated dough product for making tender, laminated biscuits comprising:
a) a layer dough comprising the following ingredients:
(i) flour,
(ii) a leavening agent,
(iii) a fat source, and
(iv) water,
said layer dough ingredients having been mixed in a manner to provide an underdeveloped biscuit dough; and
a) solid fat layers, wherein the solid fat layers alternate with the layer dough;
said layer dough and said solid fat layers being provided as a laminated product of at least about 16 fat layers;
wherein, when baked, said tender laminated biscuit product has a BSV of at least about 2 cc/g, and has no observable recoverable compression region in a Compression Profile Evaluation.

2. The laminated dough product of claim 1, wherein the layer dough has an average unbaked thickness of from about 100-1000 microns.

3. The laminated dough product of claim 1, wherein the layer dough has an average unbaked thickness of from about 150-500 microns.

4. The laminated dough product of claim 1, wherein the fat layer has an average unbaked thickness of from about 20-350 microns.

5. The laminated dough product of claim 1, wherein the fat layer has an average unbaked thickness of from about 50-200 microns.

6. The laminated dough product of claim 1, wherein the layer dough has a baked thickness of from about 150 to about 500 mm.

7. The laminated dough product of claim 1, wherein the layer dough comprises, when baked, a plurality of bubbles of average size of 0.25 to about 1.25 mm.

8. The laminated dough product of claim 1, wherein the solid fat layer is from about 12 to about 17% by weight of the total unbaked laminated dough product.

9. The laminated dough product of claim 1, wherein the layer dough has an extensibility of about 30 to about 175 mm.

10. The laminated dough product of claim 1, wherein the layer dough has an extensibility of about 70 to about 100 mm.

11. The laminated dough product of claim 1, wherein the layer dough has a Farinograph maximum resistance of about 650 to about 1000 B.U., and reaches a peak of resistance in a time period of greater than about 7 minutes.

12. The laminated dough product of claim 1, wherein the layer dough has a resistance at 30 mm extension of about 410-550 BU.

13. A frozen unproofed laminated dough product for making tender, laminated biscuits comprising:
a) a layer dough comprising the following ingredients:
(i) flour,
(ii) a leavening agent,
(iii) a fat source, and
(iv) water;
said layer dough ingredients having been mixed in a manner to provide an underdeveloped biscuit dough; and
b) solid fat layers, wherein the solid fat layers alternate with the layer dough;
said layer dough and said solid fat layers being provided as a laminated product of at least about 16 fat layers,
wherein, when baked without being thawed or proofed before baking, said frozen unproofed laminated dough product has a BSV of at least about 2 cc/g, and has no observable recoverable compression region in a Compression Profile Evaluation.

14. The laminated dough product of claim 13, wherein the layer dough has an average unbaked thickness of from about 100-1000 microns.

15. The laminated dough product of claim 13, wherein the layer dough has an average unbaked thickness of from about 150-500 microns.

16. The laminated dough product of claim 13, wherein the fat layer has an average unbaked thickness of from about 20-350 microns.

17. The laminated dough product of claim 13, wherein the fat layer has an average unbaked thickness of from about 50-200 microns.

18. The laminated dough product of claim 13, wherein the layer dough has a baked thickness of from about 150 to about 500 mm.

19. The laminated dough product of claim 13, wherein the layer dough comprises, when baked, a plurality of bubbles of average size of 0.25 to about 1.25 mm.

20. The laminated dough product of claim 13, wherein the solid fat layer is from about 12 to about 17% by weight of the total unbaked laminated dough product.

21. The laminated dough product of claim 13, wherein the layer dough has an extensibility of about 30 to about 175 mm.

22. The laminated dough product of claim 13, wherein the layer dough has an extensibility of about 70 to about 100 mm.

23. The laminated dough product of claim 13, wherein the layer dough has a Farinograph maximum resistance of about 650 to about 1000 B.U., and reaches a peak of resistance in a time period of greater than about 7 minutes.

24. The laminated dough product of claim 13, wherein the layer dough has a resistance at 30 mm extension of about 410-550 BU.

25. A baked tender, laminated biscuit comprising at least about 16 crumb layers in a baked laminated array, wherein said tender laminated biscuit product has a BSV of at least about 2 cc/g, and has no observable recoverable compression region in a Compression Profile Evaluation.

26. A method for preparing an unbaked, tender, laminated biscuit, comprising
a. Preparing an underdeveloped dough by mixing a dough composition comprising the following ingredients:
(i) flour,
(ii) a leavening agent,
(iii) a fat source, and
(iv) water
in a manner to provide an underdeveloped biscuit dough;
b. forming said dough in a layer to form a layer dough;
c. providing solid fat;
d. laminating said layer dough with said solid fat;
e. lapping said dough/solid fat laminate to form a laminate body having at least about 16 fat layers; and
f. cutting said laminate body to a desired biscuit shape;
wherein, when baked, said tender laminated biscuit product has a BSV of at least about 2 cc/g, and has no observable recoverable compression region in a Compression Profile Evaluation.

27. A method for preparing a baked, tender, laminated biscuit, comprising:
a. Providing the frozen laminated biscuit of claim 13,
b. Placing said biscuit in an oven without an intermediate thawing or proofing step;
c. Baking said frozen laminated biscuit to a BSV of at least about 2 cc/g.
